(19) United States
(12) Patent Application Publication
(10) Pub. No.: US 2026/0027714 A1
(43) Pub. Date: Jan. 29, 2026

(54) PROGRAM GENERATION APPARATUS, CONTROL APPARATUS, AND PROGRAM

(71) Applicant: FANUC CORPORATION, Yamanashi (JP)

(72) Inventors: Yuutarou TAKAHASHI, Yamanashi (JP); Yuta NAMIKI, Yamanashi (JP); Jun WADA, Yamanashi (JP)

(21) Appl. No.: 18/994,025

(22) PCT Filed: Aug. 19, 2022
(86) PCT No.: PCT/JP2022/031313

§ 371 Date: Jan. 14, 2025

(51) Int. Cl. B25J 9/16; B65B 69/00

(52) U.S. Cl. CPC B25J 9/1666; B65B 69/00

(57) ABSTRACT

An object is to facilitate creation of a robot program for moving a workpiece in a container. A program generation apparatus 2 according to the present embodiment includes: reception means 21 for receiving, on a workpiece coordinate system, a start position and a start posture for starting a contact operation for contacting a workpiece stacked in bulk in a container 300, and a movement amount and a posture change amount of the contact operation, and generation means 27 for generating a robot program for a target workpiece in the container, based on the received start position, start posture, movement amount, and posture change amount.

### RELATED APPLICATIONS

The present application is a National Phase of International Application No. PCT/JP2022/031313 filed Aug. 19, 2022.

### TECHNICAL FIELD

Embodiments of the present invention relate to a program generation apparatus, a control apparatus, and a program.

### BACKGROUND ART

There is known a technique for using a robot to take out a plurality of so-called workpieces stacked in bulk, which are placed at irregular intervals and in irregular orientations in a container or the like (for example, see Patent Literature 1). For example, the robot is controlled so that the robot or a hand mounted on the robot does not collide with the container in the operation of taking out the workpieces stacked in bulk. Specifically, information such as the shapes and dimensions of the robot, the hand, and the container is registered in advance, and it is determined by calculation whether or not the robot and the hand interfere with the container when the take-out operation is performed for each of a plurality of take-out positions corresponding to the plurality of workpieces stored in the container. Then, the workpiece determined to interfere is excluded from the targets of the take-out operation, the workpiece to be actually the target of the take-out operation is determined from the workpieces determined not to interfere, and the take-out operation is executed.

However, while workpieces are taken out from the container, a workpiece may end up at a position where the workpiece cannot be taken out with a normal take-out operation, such as in a corner or against a wall of the container. For example, in order to cope with such a case, a robot program for moving a workpiece in a container by a robot hand is created in order to move a workpiece placed at a position where it cannot be taken out with a normal take-out operation to a position where it can be taken out with the normal take-out operation.

### CITATION LIST

### Patent Literature

Patent Literature 1: Japanese Unexamined Patent Application Publication No. 2014-205209

### SUMMARY

### Problem to be Solved

However, if the robot program is created incorrectly, the robot may collide with the wall of the container, and the robot, the container, and the workpiece may be damaged. In addition, the creation of such a robot program often requires specialized knowledge of the operation of the robot, the operation of taking out workpieces stacked in bulk, and the like. Therefore, it is desired to propose a technique capable of easily creating a robot program for moving a workpiece in a container.

### Solution to Problem

A program generation apparatus according to the present embodiment generates a program for causing a robot to execute a contact operation for contacting a workpiece stacked in bulk a container. The program generation apparatus includes reception means for receiving, on a workpiece coordinate system, a start position and a start posture for starting the contact operation, and a movement amount and a posture change amount of the contact operation, and generation means for generating a robot program for a target workpiece in the container, based on the received start position, start posture, movement amount, and posture change amount.

### BRIEF DESCRIPTION OF THE DRAWINGS

FIG. 1 shows a robot system including a control apparatus according to a first embodiment.

FIG. 2 is a hardware configuration diagram of the control apparatus shown in FIG. 1.

FIG. 3 is a flowchart showing an example of the procedure of a workpiece take-out operation by the control apparatus shown in FIG. 1.

FIG. 4 is a functional block diagram of the control apparatus shown in FIG. 1.

FIG. 5 shows an example of a reception screen created by a reception screen creation unit shown in FIG. 4.

FIG. 6 shows an example of a management table stored in a storage unit shown in FIG. 4.

FIG. 7 shows the start position and the movement amount of a shifting operation on a workpiece coordinate system.

FIG. 8 is a supplementary diagram for explaining a selection process of a shifting operation parameter set by a shifting operation program generation unit shown in FIG. 4.

FIG. 9 is a functional block diagram of a control device according to a second embodiment.

FIG. 10 shows an example of a reception screen created by a reception screen creation unit shown in FIG. 9.

FIG. 11 shows an example of a management table stored in a storage unit shown in FIG. 9.

FIG. 12 is a supplementary diagram for explaining a modification process by a modification unit shown in FIG. 9.

FIG. 13 is a functional block diagram of a control apparatus according to a third embodiment.

FIG. 14 shows an example of a reception screen created by a reception screen creation unit shown in FIG. 13.

FIG. 15 shows an example of a management table stored in a storage unit shown in FIG. 13.

### DETAILED DESCRIPTION

Hereinafter, control apparatuses according to embodiments of the present invention will be described with reference to the drawings. In the following description, constituent elements having substantially the same function and configuration are denoted by the same reference numeral, and repetitive descriptions will be given only where necessary.

Control apparatuses according to embodiments of the present invention have a function of generating a contact operation program for executing a contact operation of physically bringing a robot or a robot hand mounted on the robot into contact with a workpiece placed at a position where the workpiece cannot be taken out with a normal take-out operation by the robot, and a function of controlling the robot in accordance with the generated contact operation program. If the workpiece can be moved with the contact operation to a position where the normal take-out operation by the robot is possible, the workpiece can be taken out with the normal take-out operation by the robot. In the first and second embodiments, a shifting operation in which the workpiece is caught by the robot hand and shifted will be described as an example of the contact operation. In the third embodiment, a pinching operation in which the workpiece is pinched by the robot hand and released in the container will be described as an example of the contact operation.

### First Embodiment

A control apparatus according to a first embodiment is a computer apparatus having a function of controlling a robot in accordance with a take-out operation program for taking out a plurality of so-called workpieces stacked in bulk, which are placed at irregular intervals and in irregular orientations in a container or the like, a function of generating a shifting operation program for shifting the plurality of workpieces stacked in bulk, and a function of controlling the robot in accordance with the generated shifting operation program.

The shifting operation based on the shifting operation program is executed for a workpiece that cannot be taken out with a normal take-out operation based on the take-out operation program. The shifting operation is an operation of bringing the robot into contact with the workpiece so that at least one of the position and the orientation of the workpiece can be changed. The workpiece moved by the shifting operation to the position and the orientation that allow the workpiece to be taken out with the normal take-out operation can be taken out with the normal take-out operation.

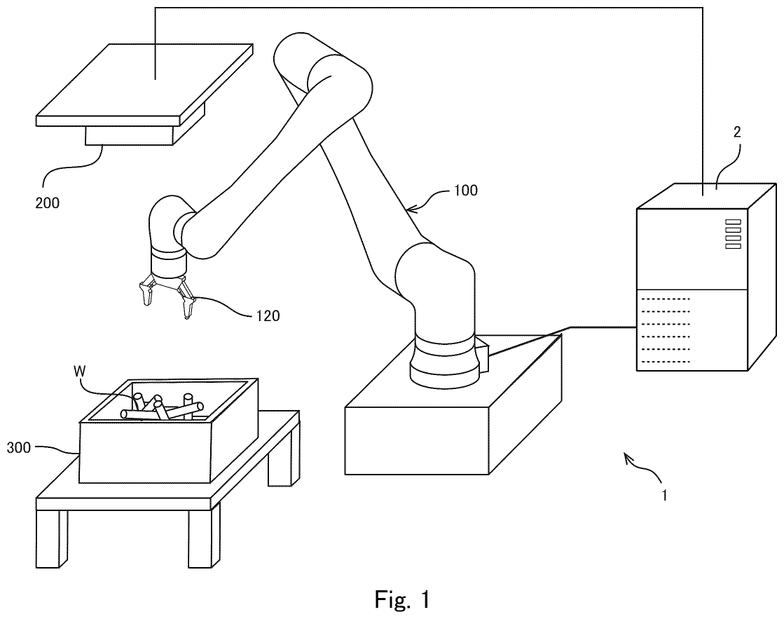

As shown in FIG. 1, a robot system 1 including a control apparatus 2 according to the first embodiment includes a robot 100 having a plurality of joints and equipped with a robot hand 120 as a tool for taking out workpieces W stacked in bulk in a container 300, a camera 200 arranged at a position where an opening of the container 300 which stores the workpieces W is viewed from above for capturing an image of the container 300, and a control apparatus 2 that controls the robot 100 and the camera 200.

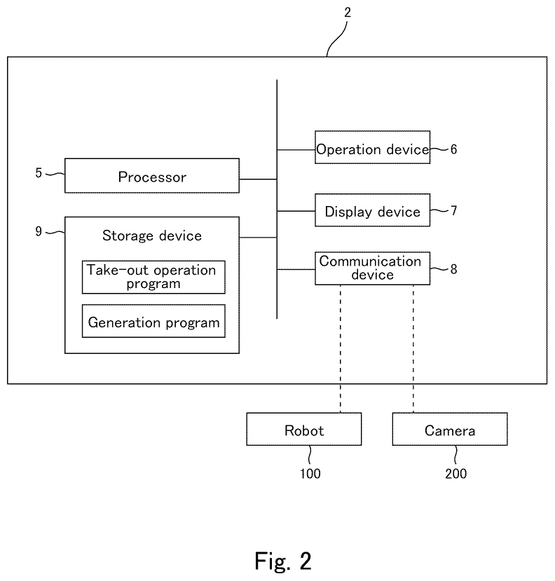

As shown in FIG. 2, the control apparatus 2 is configured by connecting hardware such as an operation device 6, a display device 7, a communication device 8, and a storage device 9 to a processor 5 such as a CPU. The operation device 6 is provided by a keyboard, a mouse, a jog, or the like. The operation device 6 may be provided by a touch panel that also serves as the display device 7, or may be provided by a dedicated pendant of the control apparatus 2. The display device 7 is provided by an LCD or the like. The communication device 8 controls transmission and reception of data between the robot 100 and the camera 200. The storage device 9 is provided by an HDD, an SSD, or the like. The storage device 9 stores therein a take-out operation program and a generation program. The storage device 9 also stores therein various types of information necessary for determining whether or not the robot 100 and the robot hand 120 interfere with the container 300 when a workpiece take-out operation is executed, such as the shapes, dimensions, and the like of the robot 100, the robot hand 120, and the container 300.

The take-out operation program is a program for causing the robot 100 to execute a take-out operation of workpieces stacked in bulk in the container 300. The take-out operation program describes a teaching position and a teaching posture of the robot 100, an operation command of the robot hand 120, an image capturing command to the camera 200, and the like in accordance with the procedure.

The generation program is a program for generating a shifting operation program. The shifting operation program is a program for causing the robot 100 to execute a shifting operation on a target workpiece. The shifting operation program describes a start position, a start posture, a movement amount, a posture change amount, a movement speed, and the like of the shifting operation. When each operation program is executed, the control apparatus 2 deciphers the operation program to generate a position command value of a motor (not shown) that drives the robot 100 by inverse kinematics, and transmits the generated position command value to a motor driver (not shown). As a result, the robot 100 can execute the operation defined by the operation program. Typically, the take-out operation program and the shifting operation program are written in a robot coordinate system that can be deciphered by the control apparatus 2. Of course, they may also be expressed in another coordinate system such as a workpiece coordinate system, and in this case, the control apparatus 2 holds a conversion table or the like for converting another coordinate system into the robot coordinate system.

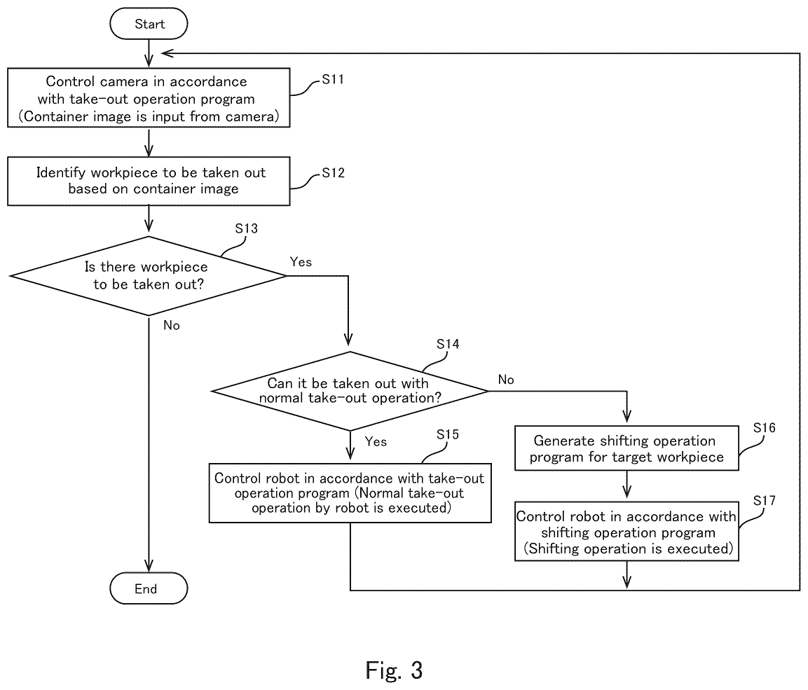

FIG. 3 is a flowchart showing a control procedure of the robot 100 and the camera 200 by the control apparatus 2 defined by the take-out operation program. As shown in FIG. 3, when the take-out operation program is executed, the control apparatus 2 controls the camera 200 in accordance with the take-out operation program (S11). Accordingly, the image of the container 300 is captured by the camera 200, and the captured container image is input to the control apparatus 2. The control apparatus 2 executes image processing on the container image for identifying the take-out position and orientation of the workpiece (S12). When there is no workpiece to be taken out (S13; NO), the robot 100 ends the workpiece take-out operation.

On the other hand, when there is a workpiece to be taken out (S13; YES), it is determined whether or not the workpiece to be taken out can be taken out with a normal take-out operation based on the take-out operation program (S14). In the process of step S14, it is determined whether or not the robot 100 and the robot hand 120 interfere with the container 300 when the normal take-out operation is performed on the workpiece, based on, for example, the dimensions and shapes of the robot 100, the robot hand 120, and the container 300, and the take-out position and orientation of the workpiece. When the robot 100 and the robot hand 120 do not interfere with the container 300, that is, when the workpiece to be taken out can be taken out with the normal take-out operation (S14; YES), the control apparatus 2 controls the robot 100 to execute the normal take-out operation (S15). As a result, the workpiece to be taken out is taken out from the container 300, and the processing returns to step S11 to execute the processing for taking out the next workpiece.

When the workpiece to be taken out cannot be taken out with the normal take-out operation (S14; NO), the control apparatus generates a shifting operation program with the workpiece that cannot be taken out as the workpiece to be shifted (S16), and controls the robot 100 in accordance with the generated shifting operation program (S17). As a result, the shifting operation is performed on the workpiece that could not be taken out with the normal take-out operation, and the workpiece is moved by the robot 100 in the container. Then, the processing returns to step S11, and the processing for taking out the workpiece to be taken out is executed again.

As described above, the processing for generating the shifting operation program and the robot control processing based on the shifting operation program are repeatedly executed until the workpiece can be taken out with the normal take-out operation. Of course, the upper limit of the number of repetitions may be set in advance, and an alert may be generated when the target workpiece cannot be taken out with the normal take-out operation even if the number of repetitions of the shifting operation on the target workpiece reaches the upper limit.

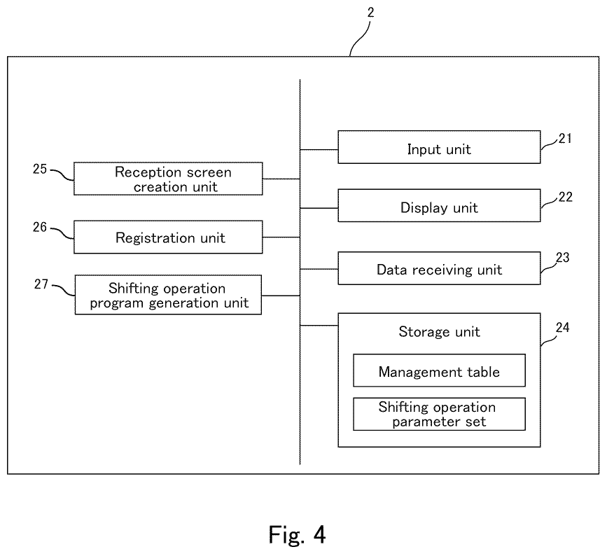

When the generation program stored in the storage device 9 is executed by the processor 5, the control apparatus 2 functions as a program generation device that generates a shifting operation program. Specifically, as shown in FIG. 4, the control apparatus 2 functions as an input unit 21, a display unit 22, a data receiving unit 23, a storage unit 24, a reception screen creation unit 25, a registration unit 26, and a shifting operation program generation unit 27.

The input unit 21 has the operation device 6 shown in FIG. 2, and inputs a user operation through the operation device 6 to the control apparatus 2. Specifically, the input unit 21 inputs a shifting operation parameter set input through the reception screen to the control apparatus 2. The shifting operation parameter set is a data set necessary for generating a shifting operation program, and includes information on a start position of the shifting operation, information on a start posture of the shifting operation, information on a movement amount of the shifting operation, and information on a rotation amount (posture change amount) of the shifting operation. Of course, information on the movement speed of the robot hand 120, an interpolation format, a movement format, and the like may be included.

The display unit 22 has the display device 7 shown in FIG. 2, and displays the reception screen created by the reception screen creation unit 25. The data receiving unit 23 has the communication device 8 shown in FIG. 2, and receives the data of the container image from the camera 200.

The storage unit 24 corresponds to the storage device 9 shown in FIG. 2. The storage unit 24 stores a management table for managing the shifting operation parameter set input through the input unit 21. Details of the management table stored in the storage unit 24 will be described later.

The reception screen creation unit 25 creates a reception screen for receiving the shifting operation parameter set. Details of the reception screen created by the reception screen creation unit 25 will be described later.

The registration unit 26 registers the shifting operation parameter set input through the reception screen in the management table in accordance with a user operation.

The shifting operation program generation unit 27 generates a shifting operation program based on the shifting operation parameter set. Specifically, the shifting operation program generation unit 27 converts the start position, the start posture, the movement amount, and the rotation amount included in the shifting operation parameter set from the workpiece coordinate system to the robot coordinate system. The data of the container image is utilized for the conversion process from the workpiece coordinate system to the robot coordinate system. Since the position of the camera 200 is fixed, the correspondence relationship between the position in the container coordinate system on the container image captured by the camera 200 and the position in the robot coordinate system is known. For example, a corner of the container 300 on the container image is defined as the origin of the container coordinate system, an axis along the long axis of the container 300 is defined as the X-axis, an axis along the short axis thereof is defined as the Y-axis, and an axis along the height direction of the container 300 orthogonal to the X-axis and the Y-axis is defined as the Z-axis.

Therefore, by identifying the position and orientation of the workpiece on the container coordinate system based on the container image, it is possible to derive the position and orientation of the workpiece coordinate system in the robot coordinate system. When the position and orientation of the workpiece coordinate system in the robot coordinate system are known, the start position, the start posture, the movement amount, and the rotation amount expressed in the workpiece coordinate system can be converted into those in the robot coordinate system. The position and orientation of the workpiece on the container image can be identified by existing image processing such as threshold processing or pattern matching processing.

The shifting operation program generation unit 27 generates a shifting operation program that describes a start position, a start posture, a movement amount, a rotation amount, a movement speed, and the like expressed in the robot coordinate system. Note that it is preferable that the shifting operation program generation unit 27 selects one shifting operation parameter set corresponding to the target workpiece of the shifting operation from a plurality of shifting operation parameter sets, and generates a shifting operation program based on the selected shifting operation parameter set. The details of the selection process of the shifting operation parameter set by the shifting operation program generation unit 27 will be described later.

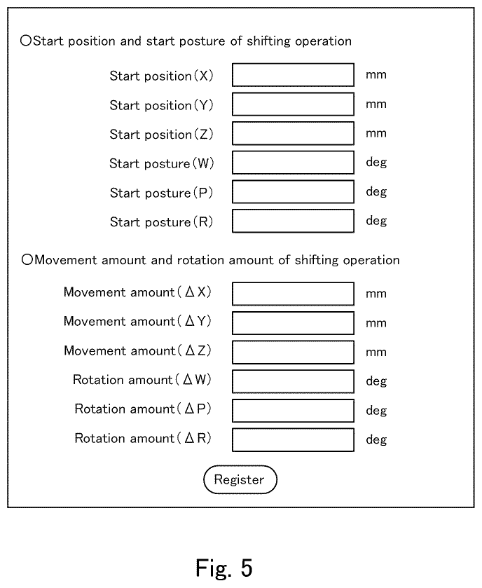

The reception screen created by the reception screen creation unit 25 will be described below with reference to FIG. 5. FIG. 5 shows an example of the reception screen. As shown in FIG. 4, the reception screen includes a plurality of input fields for receiving a shifting operation parameter set and a register button for registering the operation parameter set received through the reception screen. The plurality of input fields for receiving a shifting operation parameter set include three input fields for receiving the start positions (X), (Y), and (Z) of the shifting operation, three input fields for receiving the start postures (W), (P), and (R) of the shifting operation, three input fields for receiving the movement amounts (ΔX), (ΔY), and (ΔZ) of the shifting operation, and three input fields for receiving the rotation amounts (ΔW), (ΔP), and (ΔR) of the shifting operation.

The start positions (X), (Y), and (Z) define the position of the robot hand 120 (the position of the reference point of the hand of the robot 100) when the shifting operation is started. The start postures (X), (P), and (R) define the posture of the robot hand 120 (the orientation of the reference point of the hand of the robot 100) when the shifting operation is started. The movement amounts (ΔX), (ΔY), and (ΔZ) define the movement direction and movement amount of the robot hand 120 in the shifting operation. The rotation amounts (ΔW), (ΔP), and (ΔR) define the posture change amount of the robot hand 120 in the shifting operation.

The end position of the shifting operation is defined by the start positions (X), (Y), and (Z) and the movement amounts (ΔX), (ΔY), and (ΔZ). Accordingly, the movement amounts (ΔX), (ΔY), and (ΔZ) and the rotation amounts (ΔW), (ΔP), and (ΔR) can be replaced with the end positions (X), (Y), and (Z) and the end postures (W), (P), and (R) of the shifting operation, respectively.

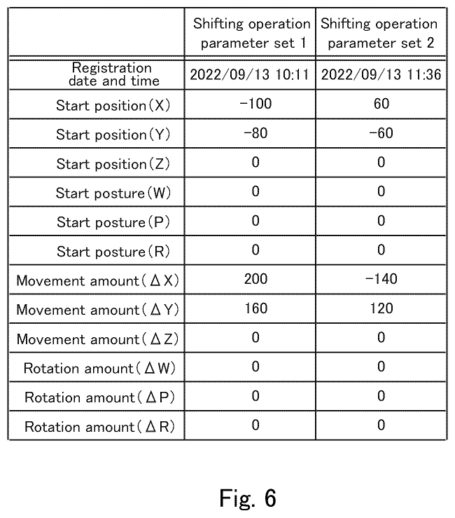

The user can input a shifting operation parameter set on the reception screen and clicking the register button to register the input shifting operation parameter set in the management table. The registered shifting operation parameter set is managed by the management table which is stored in the storage unit 24. As shown in FIG. 6, at least one shifting operation parameter set is managed in the management table together with registration date and time information.

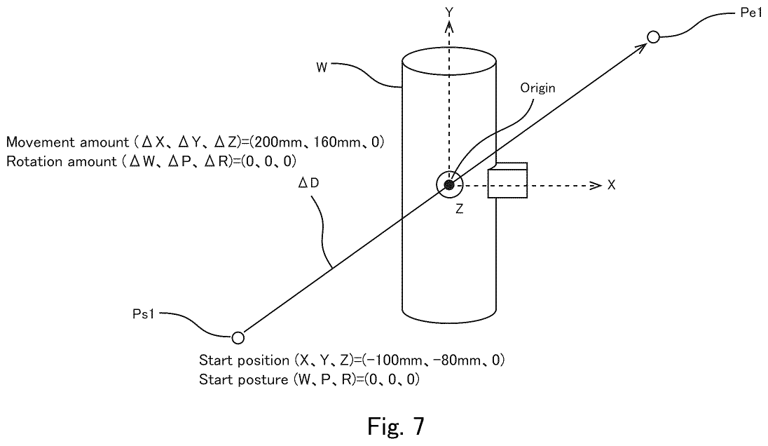

The start positions (X), (Y), and (Z), the start postures (W), (P), and (R), the movement amounts (ΔX), (ΔY), and (ΔZ), and the rotation amounts (ΔW), (ΔP), and (ΔR) are input in the workpiece coordinate system. That is, the start positions (X), (Y), and (Z) correspond to positions on the three orthogonal axes of the workpiece coordinate system. The start postures (W), (P), and (R) correspond to rotation angles around the three orthogonal axes of the workpiece coordinate system. The movement amounts (ΔX), (ΔY), and (ΔZ) correspond to the movement amounts along the three orthogonal axes of the workpiece coordinate system. The rotation amounts (ΔW), (ΔP), and (ΔR) correspond to the rotation change amounts around the three orthogonal axes of the workpiece coordinate system. The workpiece coordinate system is a coordinate system defined by the target workpiece of the shifting operation. As shown in FIG. 7, for example, when a cylindrical body having a protrusion on the outer peripheral surface is the workpiece, the three orthogonal axes of the workpiece coordinate system are defined as follows. That is, the center position of the cylindrical body is defined as the origin of the workpiece coordinate system, the axis parallel to the center line of the cylindrical body is defined as the Y-axis, the axis orthogonal to the outer peripheral surface of the workpiece and parallel to the center line of the protrusion is defined as the X-axis, and the axis orthogonal to both the X-axis and the Y-axis is defined as the Z-axis.

If the start position, the start posture, the movement amount, and the rotation amount can be input in a coordinate system other than the workpiece coordinate system, they need not be input based on the three orthogonal axes of the workpiece coordinate system. For example, they may be input based on another coordinate system, such as a cylindrical coordinate system or a polar coordinate system, depending on the workpiece.

For example, the shifting operation start position Ps1 and movement amount ΔD in FIG. 7 respectively indicate the start position (−100 mm, 80 mm, 0 mm) and movement amount (200 mm, 160 mm, 0 mm) of a shifting operation parameter set 1 managed by the management table in FIG. 6. As shown in FIG. 7, the movement trajectory of the shifting operation by the robot hand 120 based on the shifting operation parameter set 1 is inclined with respect to the center line of the workpiece from the side of the outer peripheral surface of the workpiece without the protrusion, through the origin of the workpiece, to the side of the outer peripheral surface of the workpiece with the protrusion.

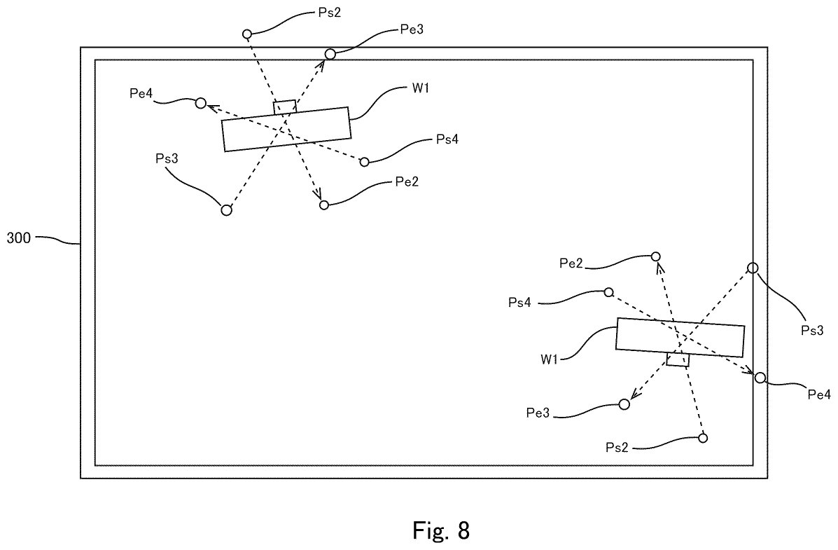

The details of the selection process of a shifting operation parameter set by the shifting operation program generation unit 27 will be described below with reference to FIG. 8. The shifting operation program generation unit 27 selects a shifting operation parameter set that satisfies selection conditions from a plurality of shifting operation parameter sets. For example, the selection conditions are as follows.

Selection condition 1: The start position and the end position are set inside the container 300.

Selection condition 2: No other workpiece is placed at the start position.

Selection condition 3: No other workpiece is placed at the end position.

Selection condition 4: No other workpiece is placed on the movement trajectory.

Selection condition 5: The start position is located closer to the center of the container 300 than the end position.

Selection condition 6: The distance of each of the start position and the end position from the inner wall surface of the container 300 is equal to or greater than a threshold value.

The shifting operation program generation unit 27 selects one shifting operation parameter set that satisfies at least the selection condition 1 and the selection condition 2 from a plurality of shifting operation parameter sets. As shown in FIG. 8, for example, when the target workpiece of the shifting operation is the workpiece W1, a shifting operation parameter set including a start position Ps4 and an end position Pe4 which satisfies the condition that the start position and the end position are set inside the container 300 and the condition that no other workpiece is placed at the start position is selected from a plurality of shifting operation parameter sets. When the target workpiece of the shifting operation is the workpiece W2, a shifting operation parameter set including a start position Ps2 and an end position Pe2 is selected from a plurality of shifting operation parameter sets.

Here, the selection conditions for selecting one shifting operation parameter from a plurality of shifting operation parameter sets are the selection condition 1 and the selection condition 2, but the selection conditions can be changed in accordance with a user instruction. For example, the selection conditions may be the selection condition 1 and the selection condition 2 plus another selection condition. Further, each shifting operation parameter set may be associated with a priority. Thus, when there are a plurality of shifting operation parameter sets that satisfy the selection conditions, one shifting operation parameter set having the highest priority among the plurality of shifting operation parameter sets that satisfy the selection conditions can be automatically selected as one shifting operation parameter set to be used to create a shifting operation program. Of course, when there are a plurality of shifting operation parameter sets that satisfy the selection conditions, the priorities associated with the plurality of shifting operation parameter sets that satisfy the selection conditions may be displayed instead of automatically selecting a shifting operation parameter set in accordance with the priority. With reference to the priorities, one shifting operation parameter set selected by the user can be identified.

The function of generating the shifting operation program of the control apparatus 2 according to the first embodiment does not generate a complicated operation program such that a single operation program can realize the shifting operation of the robot 100 on the workpiece that can be placed in various positions and orientations in the container. The function of generating the shifting operation program of the control apparatus 2 according to the first embodiment is the one for generating a shifting operation program for causing the robot 100 to execute a simple contact operation on the workpiece. Therefore, the user can generate the shifting operation program only by inputting a shifting operation parameter set (start position, start posture, movement amount, rotation amount) on the reception screen provided by the control apparatus 2.

Since the user can input the shifting operation parameter set received on the reception screen in the workpiece coordinate system, there is no need to consider the position and orientation of the workpiece in the container, and the shifting operation parameter set can be set in advance by considering only the movement trajectory of the robot hand 120 with respect to the workpiece. This also contributes to the facilitation of the generation of the shifting operation program.

Since the user knows the position and orientation of the workpiece on the workpiece coordinate system in advance, it can be said that the operation of inputting the start position, the start posture, the movement amount, and the rotation amount so that at least the robot hand 120 has a movement trajectory on which it comes into contact with the workpiece is much easier than when generating an operation program that involves many cases. Since only the movement trajectory of the robot hand 120 needs to be considered, expert knowledge on the operation of the robot 100 and the take-out operation of the workpieces stacked in bulk is not necessarily required. Therefore, the control apparatus 2 according to the first embodiment can easily create a shifting operation program for causing the robot 100 to execute a shifting operation for changing the position and orientation of the workpiece by shifting the workpiece in the container (contacting the workpiece).

Further, by registering a plurality of shifting operation parameter sets having different movement trajectories with respect to the workpiece through the reception screen, one shifting operation parameter set capable of realizing a shifting operation on the target workpiece of the shifting operation can be selected from the plurality of shifting operation parameter sets. This can suppress the occurrence of situations where the shifting operation cannot be executed, such as a situation where the start or end position of the shifting operation is set outside the container 300, or a situation where another workpiece is placed at the start position of the shifting operation.

### Second Embodiment

A control apparatus according to a second embodiment is an apparatus having a function of modifying the movement amount of the shifting operation parameter set set by the shifting operation program generation unit 27 in addition to the shifting operation program generation function of the control apparatus 2 according to the first embodiment.

Since the hardware configuration of a control apparatus 3 according to the second embodiment is the same as that of the control apparatus 2 according to the first embodiment, the description thereof will be omitted (see FIG. 2).

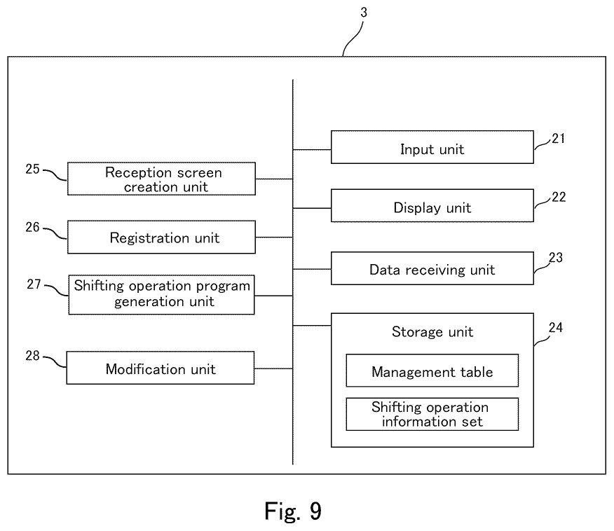

As shown in FIG. 9, the control apparatus 3 according to the second embodiment has a modification unit 28 in addition to the functions shown in the functional block diagram of the control apparatus 2 according to the first embodiment shown in FIG. 4.

The input unit 21 inputs a shifting operation parameter set input through the reception screen to the control apparatus. The shifting operation information set includes a shifting operation parameter set, information about on/off of a function of limiting the approach of the robot 100 to the inner wall surface of the container 300 (hereinafter referred to as an approach limiting function), and information about a limit distance to which the robot 100 can approach the inner wall surface of the container 300 when the approach limiting function is turned on (hereinafter referred to as an approach limit distance).

The storage unit 24 stores therein a management table for managing the shifting operation information set input through the input unit 21.

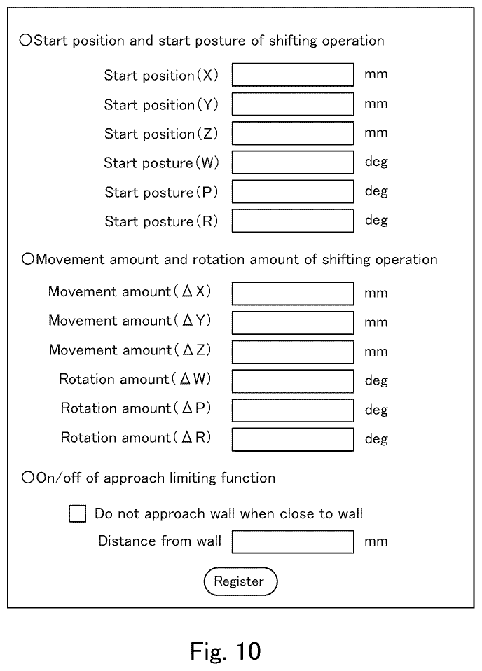

The reception screen creation unit 25 creates a reception screen for receiving the shifting operation information set. As shown in FIG. 10, the reception screen created in the second embodiment is configured by adding, to the acceptance screen of the first embodiment, a check box for receiving on/off of the approach limiting function and an input field for receiving the approach limit distance when the approach limiting function is selected to be on.

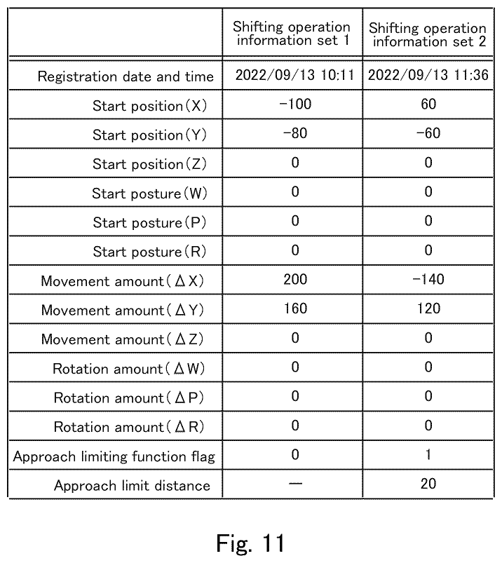

The registration unit 26 registers the shifting operation information set input through the reception screen in the management table. As shown in FIG. 11, the management table of the second embodiment is a table obtained by adding two management items of an approach limiting function flag and an approach limit distance to the management table of the first embodiment. The approach limiting function flag “0” means that the approach limiting function is turned off, and the approach limiting flag “1” means that the approach limiting function is turned on. The approach limit distance “20” means that a position of 20 mm from the inner wall surface of the container 300 is the limit distance to which the robot hand 120 can approach.

The shifting operation program generation unit 27 generates a shifting operation program based on the shifting operation information set.

The modification unit 28 modifies the shifting operation information set set by the shifting operation program generation unit 27. The modification process by the modification unit 28 is executed when the approach limiting function is ON.

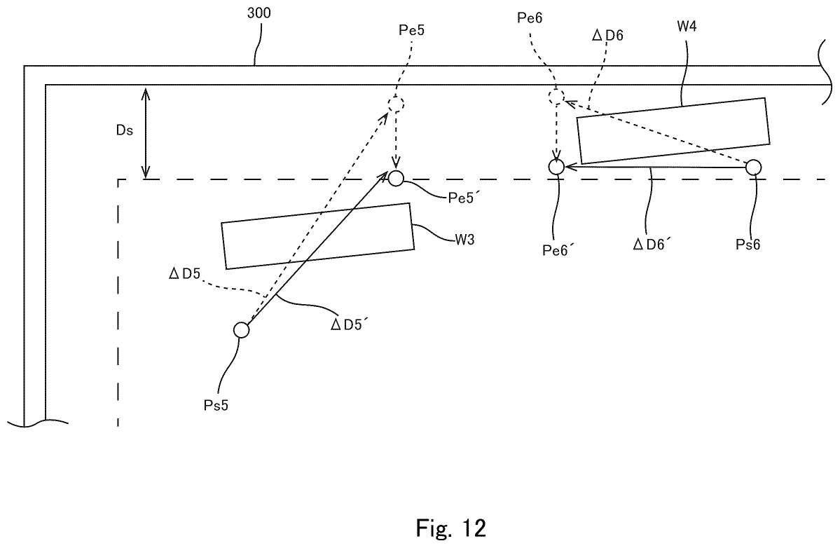

When it is determined that the position (end position) after the movement of the robot 100 by the shifting operation approaches within the approach limit distance from the inner wall surface of the container 300, the modification unit 28 modifies the movement amount along each of the three orthogonal axes so that the end position is farther from the inner wall surface of the container 300 than the approach limit distance. As shown in FIG. 12, it is assumed that the end position Pe5 derived from the start position Ps5 and the movement amount ΔD5 of the shifting operation with respect to the workpiece W3 approaches the approach limit distance Ds from the inner wall surface of the container 300.

The modification unit 28 modifies the movement amount ΔD5 so that the end position Pe5 is set to a position farther from the inner wall surface of the container 300 than the approach limit distance Ds. Specifically, the modification unit 28 converts the end position Pe5 from the workpiece coordinate system to the container coordinate system based on the container image. Based on the end position Pe5 expressed in the container coordinate system and the position of the inner wall surface of the container 300 expressed in the container coordinate system, the end position Pe5 is modified to the end position Pe5′. Then, the movement amount ΔD5 is modified to the movement amount ΔD5′ based on the start position Ps5 and the modified end position Pe5′.

When it is determined that both the start position and the end position of the shifting operation approach within the approach limit distance Ds from the inner wall surface of the container 300, the modification unit 28 modifies the movement amount so that the movement direction component toward the inner wall surface of the container 300 becomes 0. As shown in FIG. 12, both the start position Ps6 and the end position Pe6 of the shifting operation with respect to the workpiece W4 are approaching within the approach limit distance Ds from the inner wall surface of the container 300. The modification unit 28 converts the end position Pe6 from the workpiece coordinate system to the container coordinate system based on the container image. Then, based on the end position Pe6 expressed in the container coordinate system and the position of the side wall of the container 300, the movement direction component along the X-axis or the movement direction component along the Y-axis of the movement amount ΔD6 is set to 0, thereby modifying the movement amount ΔD6 to the movement amount ΔD6′.

The control apparatus 3 according to the second embodiment has the same functions as those of the control apparatus 2 according to the first embodiment, and therefore has the same effects as those of the control apparatus 2 according to the first embodiment. Further, the control apparatus 3 according to the second embodiment can generate a shifting operation program in which the end position set at a position close to the inner wall surface of the container 300 is automatically modified to a position far from the inner wall surface of the container 300. Since the approach of the robot hand 120 to the side wall of the container 300 can be limited, the possibility that the robot hand 120 of the robot 100 during the shifting operation collides with the side wall of the container 300 can be reduced compared to the case where the approach of the robot hand 120 to the side wall of the container 300 is not limited.

When both the start position and the end position are set to positions close to the side wall of the container, the control apparatus 3 according to the second embodiment modifies the movement amount so that the movement direction component toward the side wall of the container 300 becomes 0, in other words, so that the movement direction becomes a direction along the side wall of the container 300. Even if the start position is close to the inner wall surface of the container 300, the robot 100 can be prevented from further approaching the inner wall surface of the container 300, so that the possibility of the robot 100 colliding with the side wall of the container 300 during the shifting operation can be reduced compared to the case where the robot 100 further approaches the inner wall surface of the container 300 from the start position which is less than the approach limit distance from the inner wall surface of the container 300.

In the first and second embodiments, the position and orientation of the workpiece in the container are changed by performing the shifting operation on the workpiece that cannot be taken out with the normal take-out operation, so that the workpiece can be taken out with the normal take-out operation. However, as long as the workpiece can be taken out with the normal take-out operation by moving the target workpiece, the operation to be performed on the workpiece that cannot be taken out with the normal take-out operation is not limited to the shifting operation.

### Third Embodiment

A control apparatus 4 according to a third embodiment is a computer apparatus having a function of controlling a robot 100 in accordance with a take-out operation program for taking out a plurality of workpieces stacked in bulk from the container 300, a function of generating a pinching operation program relating to a pinching operation for pinching an end point of a workpiece stacked in bulk in the container, moving it in the container, and releasing it in the container, and a function of controlling the robot 100 in accordance with the generated pinching operation program. The pinching operation based on the pinching operation program is executed for a workpiece that cannot be taken out with the normal take-out operation based on the take-out operation program. The pinching operation is a series of operations of grasping a target workpiece at a position offset from a normal grasping position, moving the target workpiece in the container, and releasing the target workpiece in the container so that at least one of the position and the orientation of the target workpiece in the container can be changed. The workpiece moved to the position and orientation that allow the workpiece to be taken out with the normal take-out operation by the pinching operation is taken out with the normal take-out operation.

Since the hardware configuration of the control apparatus 4 according to the third embodiment is the same as that of the control apparatus 2 according to the first embodiment, the description thereof will be omitted (see FIG. 2).

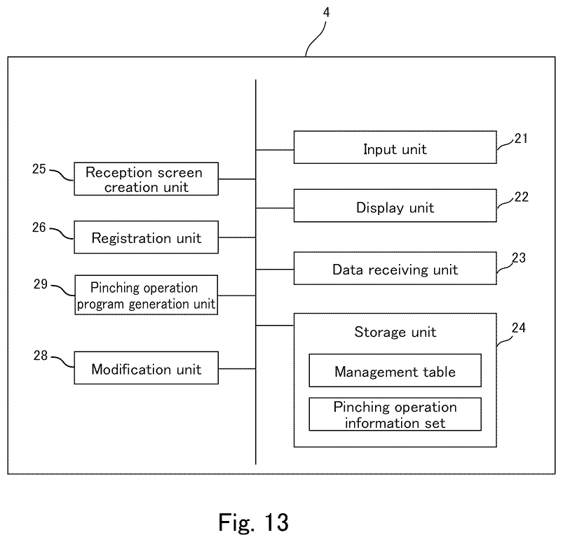

As shown in FIG. 13, the control apparatus 4 according to the third embodiment is obtained by replacing the shifting operation program generation unit 27 of the functional block diagram of the control apparatus 3 according to the second embodiment shown in FIG. 9 with a pinching operation program generation unit 29.

The input unit 21 inputs a pinching operation information set input through the reception screen to the control apparatus. The pinching operation information set includes a pinching operation parameter set, information about on/off of the approach limiting function, information about the approach limit distance when the approach limiting function is turned on, and information about whether or not to execute movement to the center position of the container 300.

The storage unit 24 stores therein a management table for managing the pinching operation information set input through the input unit 21.

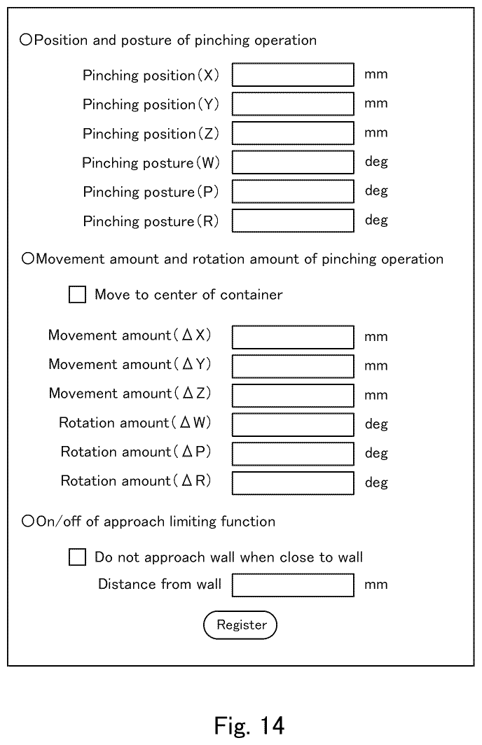

The reception screen creation unit 25 creates a reception screen for receiving the pinching operation information set. As shown in FIG. 14, the reception screen created in the third embodiment is configured by adding a check box for receiving the selection of whether or not to execute the movement to the center position of the container 300 to the reception screen created in the second embodiment. In addition, the term “shifting operation” has been replaced with “pinching operation”. By checking a check box for receiving the selection of whether or not to execute the movement to the center position of the container 300 instead of inputting the amounts of movement (X), (Y), and (Z), the user can move the robot hand 120 after pinching the workpiece to the center position of the container 300 and release the pinched workpiece to the center position of the container 300.

It is desirable that the release position is as central as possible in the container 300 so that the workpiece is not placed against the wall of the container 300 again. However, since the amounts of movement (ΔX), (ΔY), and (ΔZ) are input in the workpiece coordinate system, the target workpiece may not be able to be moved to the center position of the container 300 depending on the orientation of the target workpiece. Therefore, by checking the check box for receiving the selection of whether or not to execute the movement to the center position of the container 300, the pinched workpiece can be released at the center position of the container 300 without fail.

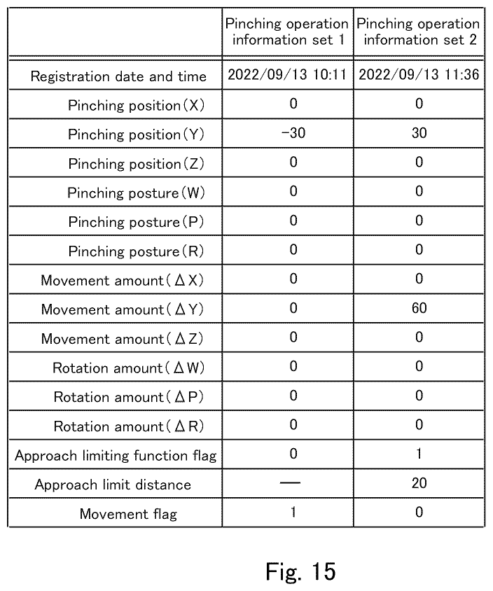

The registration unit 26 registers the pinching operation information set input through the reception screen in the management table. As shown in FIG. 15, the management table of the third embodiment manages the pinching operation information set together with registration date and time information. The movement flag “0” means that the robot hand 120 is not moved to the center position of the container 300 after the workpiece is pinched by the robot hand 120, and the movement flag “1” means that the robot hand 120 is moved to the center position of the container 300 after the workpiece is pinched by the robot hand 120. When the check box for receiving the selection of whether or not to execute the movement to the center position of the container 300 is checked and numerical values are input to the amounts of movement (ΔX), (ΔY), and (ΔZ), the amounts of movement of the robot hand 120 after pinching the workpiece are the sums of the amounts of movement required to move the container 300 to the center position and the input amounts of movement (ΔX), (ΔY), and (ΔZ).

The pinching operation program generation unit 29 generates a pinching operation program based on the pinching operation information set. The pinching operation program describes a movement command to the pinching position, a pinching operation command, a movement command to the release position, a release operation command, a movement speed, and the like. The movement command to the pinching position can be generated based on the pinching position and the pinching posture. The movement command to the release position can be generated based on the movement amount and the rotation amount. Further, when the check box for receiving the selection of whether or not to execute the movement to the center position of the container 300 is checked, the movement amount from the pinching position to the center position of the container 300 can be identified based on the position of the workpiece and the center position of the container 300 identified by the container image, thereby generating the movement command to the release position. Note that the pinching operation command and the release operation command are operation commands defined in advance.

The modification unit 28 modifies the pinching operation information set set by the pinching operation program generation unit 29. The processing of the modification unit 28 of the control apparatus 4 according to the third embodiment is the same as that in the second embodiment, and descriptions thereof will be omitted.

The control apparatus 4 according to the third embodiment is different from the control apparatus 3 according to the second embodiment only in the way of moving the workpiece in the container which could not be taken out with the normal take-out operation, and the result of this operation is the same: the workpiece can be moved to a position where it can be taken out with the normal take-out operation. Thus, the control apparatus 4 according to the third embodiment has the same effects as the control apparatus 3 according to the second embodiment.

Further, for example, when the workpiece to be contacted is propped up close to the side wall of the container 300 and is surrounded by other workpieces, it is more likely that the robot 100 can move the workpiece without stopping due to contact by pulling out the workpiece with the pinching operation than by the shifting operation. On the other hand, when the workpiece to be contacted is placed at a position where it cannot be pinched, the shifting operation must be selected. In this way, the contact operation to be executed may be automatically selected between the shifting operation and the pinching operation in accordance with the state of the workpiece to be contacted, such as the position and orientation of the workpiece to be contacted and the positions and orientations of the surrounding workpieces.

In addition, since the pinching operation is to actually pinch, move, and release the workpiece, if the release operation is slowed down, the load applied to the workpiece by the pinching operation is small, and the value of the load may be made constant regardless of the position and orientation of the workpiece. On the other hand, the shifting operation is to actually bring the robot hand 120 into contact with the workpiece and move the workpiece inside the container 300. Therefore, in the case of moving the workpieces piled up or the workpieces leaned against the side wall of the container 300, there is a possibility that a large load is applied by dropping the workpieces onto the container 300. Therefore, from the viewpoint of reducing the load applied to the workpiece, the control apparatus 4 according to the third embodiment which employs the pinching operation as the operation to contact the workpiece may be superior to the control apparatuses 2 and 3 according to the first and second embodiments which employ the shifting operation. In this way, one of the shifting operation and the pinching operation may be automatically set and preferentially executed in accordance with the type of the workpiece.

Further, if the workpiece has a complicated shape and there is no position where the workpiece can be grasped other than the take-out position, the shifting operation must be selected. In this way, the contact operation to be executed may be automatically selected between the shifting operation and the pinching operation depending on the shape of the workpiece.

As long as the position and orientation of the workpiece inside the container 300 can be identified, the data used for the identification process is not limited to the container image captured by the camera 200. For example, instead of the camera 200, a sensor capable of acquiring three-dimensional point group data of a subject and a sensor and two cameras capable of acquiring three-dimensional point group data and a two-dimensional camera image can be used.

The first and second embodiments, in which the shifting operation program is generated, and the third embodiment, in which the pinching operation program is generated, may be combined. In this case, a pull-down menu for setting the target operation to the shifting operation or the pinching operation may be provided on the reception screen. It is possible to generate both the shifting operation program and the pinching operation program and cause the robot 100 to execute either one of the operations in accordance with a predetermined rule. For example, the shifting operation and the pinching operation are alternately performed. That is, for a workpiece that cannot be taken out with the normal take-out operation, the robot 100 is caused to first perform the shifting operation, and if the target workpiece still cannot be taken out with the normal take-out operation, the robot 100 is then caused to perform the pinching operation. By combining a plurality of operations that differ in the way the workpiece is moved, the possibility of moving the workpiece to a position and orientation that allow the workpiece to be taken out with the normal take-out operation is improved compared with the case where a single operation is repeated, and the occurrence of a situation in which the workpiece cannot be taken out can be suppressed.

Further, one contact operation of the shifting operation and the pinching operation may be automatically selected and executed based on the height of the operation start point to the target workpiece in the container or the height of the target workpiece in the container, such as the operation being executed when the height of the start position of the shifting operation or the pinching operation to the target workpiece in the container is high.

In the present embodiment, the generated program installed in the control apparatus 2, 3, 4 may be distributed by being recorded in various types of recording media such as removable media, or may be distributed by being downloaded to a user's computer via a network.

While embodiments of the present disclosure have been described in detail, the present disclosure is not limited to the individual embodiments described above. These embodiments may be subjected to various additions, substitutions, modifications, partial deletions, etc., without departing from the gist of the invention or the idea and spirit of the present invention as derived from the contents described in the claims and their equivalents. For example, in the above-described embodiments, the order of the operations and the order of the processes are shown as examples, and the present invention is not limited thereto. The same applies to the case where numerical values or formulas are used in the description of the above-described embodiments.

1. A program generation apparatus for generating a robot program for causing a robot to execute a contact operation for contacting a workpiece stacked in bulk in a container, comprising:
a receiving unit configured to receive, on a workpiece coordinate system, a start position and a start posture for starting the contact operation, and a movement amount and a posture change amount of the contact operation; and
a generation unit configured to generate the robot program for a target workpiece in the container, based on the received start position, start posture, movement amount, and posture change amount.

2. The program generation apparatus according to claim 1, wherein the receiving unit receives positions on three orthogonal axes of the workpiece coordinate system as the start position, receives rotation angles around the three orthogonal axes as the start posture, receives movement amounts along the three orthogonal axes as the movement amount, and receives rotation amounts around the three orthogonal axes as the posture change amount.

3. The program generation apparatus according to claim 1, wherein
the receiving unit receives a plurality of contact operation parameter sets, each including the start portion, the start posture, the movement amount, and the posture change amount, and
the generation unit selects one contact operation parameter set from the plurality of contact operation parameter sets based on a position and orientation of the target workpiece in the container, and generates the robot program based on the selected one contact operation parameter set.

4. The program generation apparatus according to claim 1, further comprising a third receiving unit configured to receive an approach limit distance of the robot with respect to an inner wall surface of the container, wherein
when it is determined that a post-movement position of the robot approaches within the approach limit distance from the inner wall surface, the generation unit modifies the movement amount so that the post-movement position of the robot becomes farther from the inner wall surface than the approach limit distance.

5. The program generation apparatus according to claim 1, wherein
the contact operation is a shifting operation to contact and shift the workpiece stacked in bulk in the container, and
the receiving unit receives a shifting start position for shifting the workpiece as the start position.

6. The program generation apparatus according to claim 1, wherein
the contact operation is a pinching operation to pinch the workpiece stacked in bulk in the container, move the workpiece in the container, and release the workpiece in the container, and
the receiving unit receives a pinching start position for pinching the workpiece as the start position.

7. The program generation apparatus according to claim 6, further comprising an other receiving unit configured to receive a movement to a center position of the container, wherein
the generation unit modifies the received movement amount based on a result of the reception of the movement to the center position of the container.

8. A control apparatus for controlling a robot to cause the robot to execute a contact operation for contacting a workpiece stacked in bulk in a container, comprising:
a receiving unit configured to receive, on a workpiece coordinate system, a start position and a start posture for starting the contact operation, and a movement amount and a posture change amount of the contact operation;
a generation unit configured to generate a robot program for causing the robot to execute the contact operation for a target workpiece in the container, based on the received start position, start posture, movement amount, and posture change amount; and
a control unit configured to control the robot in accordance with the generated robot program.

9. A non-transitory storage medium storing a program causing a computer to implement:
receiving, on a workpiece coordinate system, a start position and a start posture for starting a contact operation for contacting a workpiece stacked in bulk in a container, and a movement amount and a posture change amount of the contact operation; and
generating a robot program for causing a robot to execute the contact operation for a target workpiece in the container, based on the received start position, start posture, movement amount, and posture change amount.
